(19) United States
(12) Patent Application Publication
(10) Pub. No.: US 2002/0065565 A1
(43) Pub. Date: May 30, 2002

(54) Electronic collection and delivery system

(76) Inventor: Eiji Okamura, Tokyo (JP)

Correspondence Address: FULBRIGHT & JAWORSKI L.L.P., 29th Floor, 865 S. Figueroa Street, Los Angeles, CA, 90017, US

(21) Appl. No.: 09/947,271

(22) Filed: Sep. 5, 2001

(30) Foreign Application Priority Data
Sep. 5, 2000 (JP) 2000-268326

(51) Int. Cl. G06F 7/00

(52) U.S. Cl. 700/21; 700/226

(57) ABSTRACT

Objective: To provide to a requesting party information on a means for shipping for the purpose of a collection and delivery agent entrusted with the collection and delivery of cargo to perform subsequent shipping and delivery and to allow the requesting party to make a selection. Means for achieving objective: Information on at least a collection site, a delivery site, and cargo is input into an Internet terminal 1, information (a database 4) on a means for shipping connecting the collection site to the delivery site is provided via a server 3, and the requesting party is allowed to freely make selections regarding a collection and delivery consignment transaction from among various selection criteria.

### FIELD OF THE INVENTION

The present invention relates to a cargo collection and delivery system, and more particularly to an electronic collection and delivery system which provides information on collection and delivery, the cheapest route, and the deliverer on an Internet terminal.

### BACKGROUND OF THE INVENTION

In the prior art, cargo collection and delivery was conducted between a requesting party and a deliverer by means of telephone, fax, and the like.

FIG. 6 shows this type of collection and delivery method, which is composed of a requesting party 8, a collector 9, a collection center 10, various means of shipping 11, a delivery center 12, a deliverer 13, and a delivery site 14. Each delivers the cargo to the other in the order they are mentioned.

In the prior art example shown in FIG. 6, the requesting party 8 consigns the collected cargo to the collector. The collector 9 receives this and collects the cargo from the requesting party 8, and afterward transport and delivery arrangements are made, and the cargo is brought into collection center 10.

In collection center 10, a plurality of cargo from a plurality of requesting parties are classified according to the areas to which they will be transported, they are then entrusted to the various means for shipping 11 that have been prepared for each area to which they will be transported, and are then sent to a delivery center 12 in each area.

In each area's delivery center 12, the arriving cargo is subdivided into each respective small area to which it will be transported to, and these are received by the deliverer 13 and delivered to each delivery site 14.

However, in this sort of prior art collection and delivery, the requesting party 8 does not obtain satisfactory service by having various means of shipping 11, the deliverer, and the method of transportation selected for him.

That is, in collection center 10, a plurality of transporters provide various means of transportation to each area, and thus it is physically possible that the transportation of cargo will be entrusted to any number of businesses. Further, in delivery center 12, a plurality of deliverers provides various delivery services to that area, and it is physically possible that cargo will be entrusted to any number of deliverers. However, in the prior art example shown in FIG. 6, the collector 9 to which the cargo is entrusted with will not provide the original requesting party 8 with an opportunity for a satisfactory selection of the transportation and delivery arrangements and is thus inconvenient.

### BRIEF SUMMARY OF THE INVENTION

An electronic collection and delivery system according to the present invention provides information related to the means of transportation which connects this collection site and said delivery site by inputting at least information relating to the collection site, the delivery site, and the cargo.

A means of inputting information relating to the collection site, the delivery site, and the cargo is an Internet terminal. The information relating to the collection site and the delivery site comprises at least an address, a telephone number, a postal code, and either or both a longitude and latitude.

Information relating to the collection site and the delivery site comprises at least coordinates on a map displayed on an Internet terminal. The coordinates on a map are indicated by some type of icon on an image, or a cursor. At least one from amongst a keyboard, a mouse, a trackball, or a joystick is used to move the coordinates on the map.

Information relating to the cargo comprises at least either the contents of the cargo, its shape, its dimensions, its weight, its method of storage, and the day of desired delivery.

Information relating to the means of transport connecting the collection site and the delivery site comprises at least any one of the price and the time required.

Information relating to the means of transport connecting the collection site and the delivery site comprises at least information relating to the collection center, the delivery center and a facility for temporarily storing the cargo in the vicinity of the collection site and the delivery site.

Information relating to the means of transport connecting the collection site and the delivery site comprises at least means composed of cooperation between at least two or more of the deliverer, the transporter, and the temporary storer. At least two or more pieces of information relating to the connecting means between the collection site and the delivery site is provided simultaneously. A facility for temporary storage is either a train station, a store, or a private residence.

### BRIEF DESCRIPTION OF DRAWINGS

FIG. 1 shows one working example of the electronic collection and delivery transaction system composed using the invention.

FIG. 2 shows one example of a screen displayed on the Internet terminal of the invention.

FIG. 3 shows one example of a screen, displayed on the Internet terminal of the invention that facilitates input of the collection site and delivery site.

FIG. 4 shows an example of a screen, displayed on the Internet terminal of the invention that facilitates the input of cargo information.

FIG. 5 shows an example of a screen, displayed on the Internet terminal of the invention that provides information on a means for shipping connecting the collection site to the delivery site.

FIG. 6 shows a conventional collection and delivery transaction method.

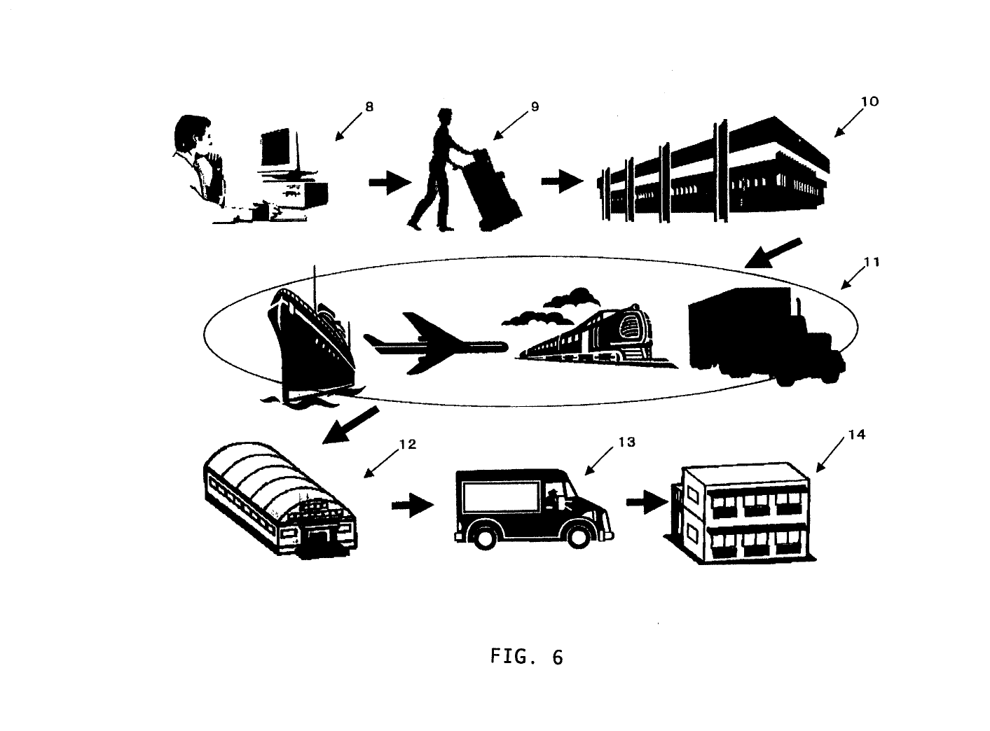

### DETAILED DESCRIPTION OF THE INVENTION

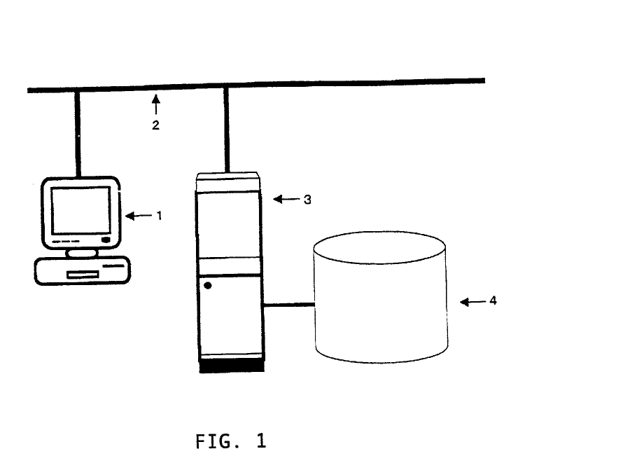

FIG. 1 shows an embodiment of an electronic collection and delivery system according to the present invention. The embodiment of FIG. 1 includes an Internet terminal 1, an Internet line 2, a server 3, and a database 4. Internet terminal 1 and server 3 are connected together via Internet line 2, another Internet line 2 connects another Internet terminal and server together, and database 4 is connected to server 3.

In an electronic collection and delivery system arranged in this manner, collection and delivery occurs by the operation of Internet terminal 1 by a requesting party.

That is, if a requesting party inputs information relating to the collection site, the delivery site, or the cargo by means of Internet terminal 1, this information is received by server 3 by way of Internet line 2. Information relating to the means of transportation between the collection site and the delivery site input is collected by database 4 connected to server 3 or another server connected to Internet line 2, and this is provided to Internet terminal 2.

Server 3 collects information provided by every collector, transporter, and deliverer through its connected server 3 and Internet line 2. Because this can be provided, it is possible to compile and provide information concerning a variety of combinations of collection means from a plurality of businesses, rather than only one business providing collection, transportation, and delivery. Further, it is also possible to provide information to compare the advantages of each of this plurality of combinations. Because there are a variety of selection parameters regarding the collection and delivery to be consigned, the requesting party is given the opportunity to freely select therefrom.

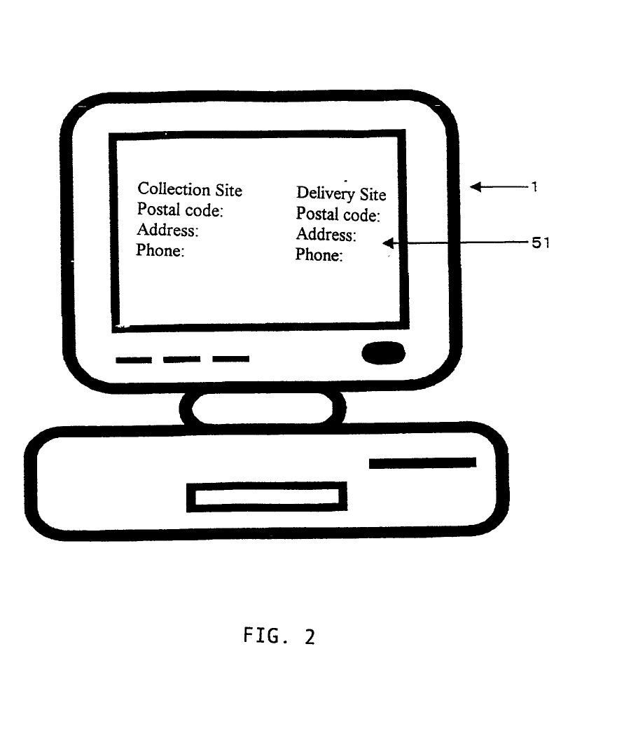

When this type of service is provided, FIG. 2 shows an example 51 of an ideal screen 5 displayed on Internet terminal 1 according to the present invention.

On the screen shown in screen 51 of FIG. 2, the postal code, address, and telephone number of the collection site and the delivery site are input and saved.

When the requesting party inputs either the postal code, address, or telephone number of a collection site and a delivery site into Internet terminal 2, server 3 can recognize those areas and can provide information concerning collection at the collection site, information relating to the transportation means connecting the collection area and the delivery area, and information concerning delivery at the delivery site.

Further, because it is possible for the requesting party to bring the cargo directly into the collection center, and it is possible to use facilities to temporarily store cargo, such as train stations, stores, private residences and the like, it is possible to provide suitable information by inputting portions of the postal code, address, and telephone number.

In this case, the information to be provided includes information concerning the collection centers in the vicinity of the collection site, and information regarding the delivery centers in the vicinity of the delivery site and temporary storage facilities. Thus, the value of using the present invention is enhanced. Moreover, it goes without saying that the latitude and longitude can also be used for the particulars of the collection site and the delivery site.

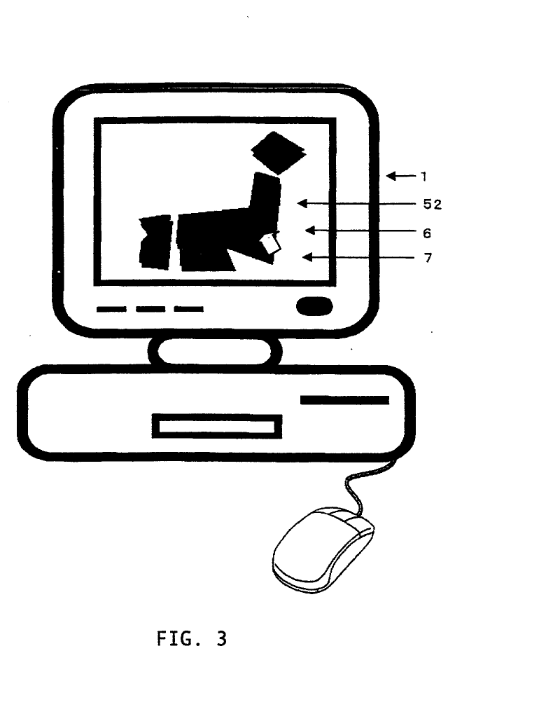

FIG. 3 shows an example 52 of an ideal screen 5 displayed on Internet terminal 1 according to the present invention for facilitating the input of the collection site and the delivery site.

Screen 52 in FIG. 3 includes a map 6 and a mouse icon 7 showing coordinates on the map. Mouse icon 7 is controlled by a mouse connected to Internet terminal 1.

The requesting party can easily display the collection site and the delivery site on this type of screen 52 by operating the mouse to point out the positions on the map. The area displayed is enlarged, and if location of the collection center, the delivery center and the temporary storage facility is displayed, the requesting party can easily make a selection regarding consigning a collection or a delivery, bringing the cargo to a collection center, or using temporary storage facilities.

It is also possible to indicate coordinates on screen 52 by means of a cursor rather than a mouse icon. Further, a keyboard, trackball, joystick or the like can be used to move the cursor rather than the aforementioned mouse.

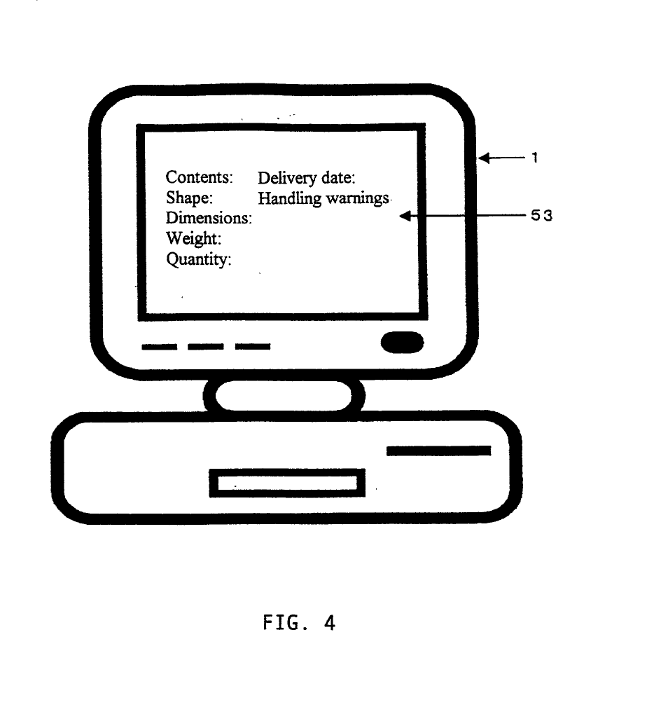

FIG. 4 shows an example 53 of an ideal screen 5 displayed on Internet terminal 1 according to the present invention for facilitating the input of information relating to the cargo.

Screen 53 shown in FIG. 4 provides an image for the requesting party, that is, the operator of Internet terminal 1, to input the contents of the cargo, its shape, its dimensions, its weight, the number of items, the date it is desired to be delivered, and instructions regarding its handling.

As for the means of collecting the cargo, the optimal route, the combination of business, price and the like will be different depending on the contents of the cargo, its dimensions, its weight, the number of items, the time it is allowed to be collected, restrictions on the handling of the cargo, and the like. By collecting this sort of information, more suitable information can be provided.

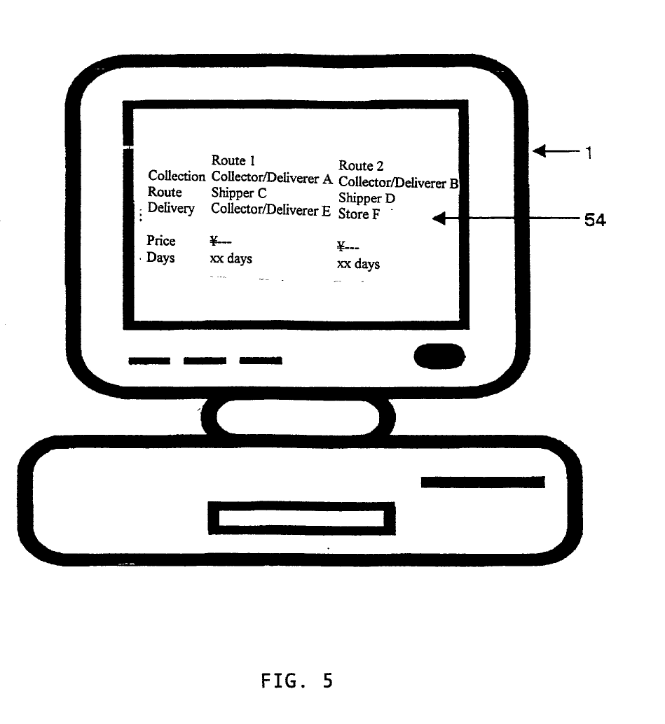

FIG. 5 shows an example 54 of an ideal screen 5 displayed on Internet terminal 1 according to the present invention for providing information relating to the means of transportation connecting the collection site and the delivery site.

Screen 55 shown in FIG. 5 provides information relating to the means of transportation connecting the collection site and the delivery site, information relating to a plurality of routes (Screen 54 displays “Route 1” and “Route 2”) by a plurality of combinations of collectors, transporters (because a transporter is generally referred to as a “route transporter”, the word “route” is displayed on screen 54), and deliverers, and information relating to the price and the number of days the delivery will take.

By providing this sort of information, it is possible for the requesting party to select the most suitable terms by himself.

As explained above, with the electronic collection and delivery system according to the present invention, it becomes possible to provide information concerning a plurality of delivery means that connect a collection site and a delivery site, and by not consigning all of the arrangements concerning the collection of cargo to one collector and providing an opportunity for the requesting party to freely select his preferences, a cheap, convenient, and high level of collection and delivery services can be provided.

1. An electronic collection and delivery system which comprises inputting information relating to at least a collection site, a delivery site, and a cargo, and providing information related to the means of transportation which connects said collection site and said delivery site.

2. The electronic collection and delivery system according to claim 1, wherein a means of inputting information relating to the collection site, the delivery site, and the cargo is an Internet terminal.

3. The electronic collection and delivery system according to claim 1, wherein information relating to the collection site, the delivery site, and the cargo comprises at least an address, a telephone number, a postal code, and either a latitude or a longitude.

4. The electronic collection and delivery system according to claim 2, wherein information relating to the collection site and the delivery site comprises at least map coordinates displayed on the Internet terminal.

5. The electronic collection and delivery system according to claim 4, wherein the map coordinates are indicated by an icon on the screen or a cursor.

6. The electronic collection and delivery system according to claim 4, wherein at least one of a keyboard, mouse, trackball, or joystick is used to move the map coordinates.

7 The electronic collection and delivery system according to claim 1, wherein information relating to the cargo comprises at least either the contents, shape, dimensions, weight, number of pieces, method of storage, or the date and time that delivery is desired.

8. The electronic collection and delivery system according to claim 1, wherein information relating to the means of transportation connecting the collection site and the delivery site comprises at least either the price or the amount of time needed.

9. The electronic collection and delivery system according to claim 1, wherein information relating to the means of transportation connecting the collection site and the delivery site comprises at least information relating to a collection center, a delivery center, and a temporary storage facility in the vicinity of the collection site and the delivery site.

10. The electronic collection and delivery system according to claim 1, wherein information relating to the means of transportation connecting the collection site and the delivery site comprises means composed of cooperation between at least two or more of the deliverer, the transporter, and the temporary storer.

11. The electronic collection and delivery system according to claim 1, wherein at least two or more pieces of information relating to the means of transportation connecting the collection site and the delivery site is provided simultaneously.

12. The electronic collection and delivery system according to claim 1, wherein the temporary storage facility is either a train station, a store, or a private residence.
